(19) United States
(12) Patent Application Publication
(10) Pub. No.: US 2024/0218130 A1
(43) Pub. Date: Jul. 4, 2024

(54) REDUCED MANUFACTURING CYCLE TIME OF POLYMER-BASED AEROGEL MATERIALS AND METHOD OF FORMING

(71) Applicant: Ford Global Technologies, LLC, Dearborn, MI (US)

(72) Inventors: Haibo Zhao, Northville, MI (US); Elena Sharnowski, Dearborn, MI (US)

(73) Assignee: Ford Global Technologies, LLC, Dearborn, MI (US)

(21) Appl. No.: 18/093,224

(22) Filed: Jan. 4, 2023

(51) Int. Cl. C08J 3/05; C08J 3/09; C08J 9/28

(52) U.S. Cl. CPC C08J 3/05; C08J 3/095; C08J 9/286; C08J 2205/026; C08J 2205/042; C08J 2329/04

(57) ABSTRACT

A polyvinyl alcohol (PVA) aerogel and methods for processing and producing the PVA includes mixing water with PVA to form a PVA mixture, mixing the PVA mixture with ethanol to form an aerogel mixture, and freeze drying the aerogel mixture to sublimate at least a portion of the water and ethanol from the aerogel mixture to form the PVA aerogel.

### FIELD

The present disclosure relates to polymer-based aerogel materials and methods for forming same.

### BACKGROUND

The statements in this section merely provide background information related to the present disclosure and may not constitute prior art.

Aerogels are highly porous structures providing excellent thermal insulating properties, and work well under catalyst loading and CO₂ capture applications. Such aerogels accordingly may be integrated into components for numerous applications, including vehicle components, and particularly for lightweight, thermally insulative vehicle components.

Various types of aerogels include silica-based aerogels and polymer aerogels, among others. Silica-based aerogels, while being relatively inexpensive to make and having adequate appearance and thermal insulating properties, suffer from brittleness, which limits their application as components in many applications requiring toughness and strength. Polymer-based aerogels in general are not as brittle, but conventional processes for producing polymer-based aerogels include freeze drying over an extended period of time, adding substantial costs. Some aerogels and aerogel processing methods, therefore, may be cost-prohibitive, inefficient, and/or result in undesirable porous structures and production of aerogels with desired qualities may be difficult to achieve on a mass scale.

These issues related to the production of aerogel-based components, particularly in automotive applications, are addressed by the present disclosure.

### SUMMARY

This section provides a general summary of the disclosure and is not a comprehensive disclosure of its full scope or all of its features.

According to one form of the present disclosure, a method of forming a polymer-based aerogel includes mixing a solvent with a water-soluble polymer to form a polymer mixture, mixing the polymer mixture with an alcohol to form an aerogel mixture, and freeze drying the aerogel mixture to sublimate at least a portion of the solvent and alcohol from the aerogel mixture to form the polymer-based aerogel.

In variations of this form, which may be implemented individually or in any combination: the solvent includes water; the alcohol includes ethanol; the water-soluble polymer includes polyvinyl alcohol; the ethanol is by volume greater than 0% to less than or equal to about 25% of the aerogel mixture; the alcohol is by volume greater than 0% to less than or equal to about 25% of the aerogel mixture; and, the alcohol is by volume about 12.5% of the aerogel mixture.

According to a second form of the present disclosure, a method of forming a polyvinyl alcohol (PVA) aerogel includes mixing water with PVA to form a PVA mixture, mixing the PVA mixture with ethanol to form an aerogel mixture, and freeze drying the aerogel mixture to sublimate at least a portion of the water and ethanol from the aerogel mixture to form the PVA aerogel.

In variations of this form, which may be implemented individually or in any combination: the ethanol is by volume greater than 0% to less than or equal to about 25% of the aerogel mixture; and the ethanol is by volume about 12.5% of the aerogel mixture; the PVA aerogel has pores having an average diameter of greater than or equal to about 6 nanometers to less than or equal to about 400 nanometers; the density of the PVA aerogel is about 0.02 g/cm³; and, the PVA aerogel has a thermal conductivity of less than or equal to about 0.0305 W/mK.

According to yet another form of the present disclosure, a method of forming a PVA aerogel includes mixing a solvent with a PVA to form a PVA mixture, mixing the PVA mixture with an alcohol to form an aerogel mixture, and freeze drying (e.g., supercritical drying) the aerogel mixture to sublimate at least a portion of the solvent and alcohol out of the aerogel mixture to form the PVA aerogel.

In variations of this form, which may be implemented individually or in any combination: the solvent includes water; the alcohol includes ethanol; the alcohol is by volume greater than 0% to less than or equal to about 25% of the aerogel mixture; and the alcohol is by volume about 12.5% of the aerogel mixture; the PVA aerogel has pores having an average diameter of greater than or equal to about 6 nanometers to less than or equal to about 400 nanometers; and, the density of the PVA aerogel is about 0.02 g/cm³.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a photograph of a polymer-based aerogel sample, Example A, according to the present disclosure;

FIG. 1B is a photograph of a polymer-based aerogel sample, Example B, according to the present disclosure;

FIG. 1C is a photograph of a polymer-based aerogel sample, Example C, according to the present disclosure;

FIG. 1D is a photograph of a polymer-based aerogel sample, Example D, according to the present disclosure;

FIG. 2A is a photograph of a polymer-based aerogel sample, Example E, according to the present disclosure;

FIG. 2B is a photograph of a polymer-based aerogel sample, Example F, according to the present disclosure;

FIG. 2C is a photograph of a polymer-based aerogel sample, Example G, according to the present disclosure;

FIG. 2D is a photograph of a polymer-based aerogel sample, Example H, according to the present disclosure;

FIG. 2E is a photograph of a polymer-based aerogel sample, Example I, according to the present disclosure;

FIG. 2F is a photograph of a polymer-based aerogel sample, Example J, according to the present disclosure;

FIG. 3A is a photograph of a polymer-based aerogel sample, Example K, after one day of freeze drying;

FIG. 3B is a photograph of a polymer-based aerogel sample, Example L, after one day of freeze drying;

FIG. 3C is a photograph of a polymer-based aerogel sample, Example K, after two days of freeze drying;

FIG. 3D is a photograph of a polymer-based aerogel sample, Example L, after two days of freeze drying;

FIG. 3E is a photograph of a polymer-based aerogel sample, Example K, after three days of freeze drying; and

FIG. 3F is a photograph of a polymer-based aerogel sample, Example L, after three days of freeze drying.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The various methods according to the present disclosure are generally used with polymer-based aerogel compositions, which are typically prepared by dissolving a polymer into a solvent (e.g., a mixture of water and alcohol) to form a polymer mixture, followed by freezing the solution such that the polymer precipitates from the solution into a gel-like, porous structure. The solvent in the prepared aerogel compositions can be substantially removed by various methods, such as freeze drying, vacuum drying, and supercritical drying. In some forms, the solvent is removed by freeze drying to sublimate the solvent from the polymer. The precipitate forms a polymer-based aerogel and remains in a porous structure, as the structure is generally inhibited from collapsing as the surface tension is virtually zero in the sublimation process.

According to one form of the present disclosure, the solvent includes an alcohol in an amount by volume of the solvent of greater than 0% to less than or equal to about 25%, including all sub-ranges. According to a variation, the alcohol is in an amount by volume of the solvent of about 12.5%. According to another variation, the alcohol is in an amount by volume of the solvent of greater than or equal to about 10% to less than or equal to about 15%. According to a further variation, the alcohol is in an amount by volume of the solvent of greater than or equal to about 7.5% to less than or equal to about 17.5%. According to yet another variation, the alcohol is in an amount by volume of the solvent of greater than or equal to about 5% to less than or equal to about 20%. According to yet other variations, the alcohol may be ethanol. In other variations, the alcohol may be methanol or monoalcohols. In yet other variations, the alcohol may include a non-alcohol, such as acetone or others that are miscible with the solvents contemplated herein and volatile. As described in greater detail below, using alcohol results in improved polymer-based aerogels that are capable of rapidly and adequately freeze-drying while maintaining the excellent mechanical and electrical properties of conventional polymer-based aerogels.

Suitable water-soluble polymers are those that may be used to form the aerogel compositions disclosed herein, and more specifically may include polymers having a solubility in water of at least 1 mg/ml at 25° C. In some variations, the polymer is in an amount of greater than or equal to about 2% w/v (percent weight by volume) to less than or equal to about 4% w/v of gram of polymer per 100 ml of solution, including all sub-ranges. In yet other variations, the polymer is in an amount of greater than or equal to about 1% w/V.

In some variations, the water-soluble polymer is a thermoplastic polymer, such as, for example, polyvinyl alcohol, polyethylene glycol, polyacrylamide, polyacrylic acid, polymethacrylic acid, cellulose, hydroxypropylmethyl cellulose, hydroxypropyl cellulose, chitosan, dextran, and dextran sulfate, among others, or a combination of any two or more thereof. In some variations, the water-soluble organic polymer is polyvinyl alcohol, polyethylene glycol, polyacrylamide, polyacrylic acid, polymethacrylic acid, among others, or a combination of any two or more thereof. According to yet other variations, the polymer is polyvinyl alcohol (PVA).

In yet other variations, the water-soluble polymer is a thermoset polymer. Suitable thermoset polymers include, for example, polymerized resorcinol-formaldehyde, phenol-formaldehyde, urea-formaldehyde, polyamic acid salt, among others, or a combination of any two or more thereof.

The aerogel compositions made according to the present disclosure have low thermal conductivity in comparison to conventional solid counterparts. For example, in some variations, the aerogel compositions have a thermal conductivity in the range of about 0.03 W/mk. In yet other variations, the aerogel compositions have a thermal conductivity of less than or equal to about 0.035 W/mk. In further variations, the aerogel compositions have a thermal conductivity of about 0.0305 W/mk.

The present aerogel compositions prepared according to the methods disclosed herein typically have a density of not more than 0.03 g/cm³. In further variations, the aerogel compositions have a thermal conductivity of about 0.02 g/cm³.

The present aerogel compositions prepared according to the methods disclosed herein typically have porous structures. In some variations, the aerogel compositions have pores having an average diameter of greater than or equal to about 6 nm to less than or equal to about 400 nm.

As noted above, in an aspect, methods of making the aerogels disclosed herein include combining a solvent, an alcohol, and a water-soluble polymer into a solution; freezing the dissolving a polymer into a solvent to form a polymer mixture; followed by freezing the solution such that the polymer precipitates from the solution into a gel-like, porous structure. The water and alcohol may then be removed by freeze drying the solution to sublimate the solvent from the polymer. The precipitate forms a polymer-based aerogel and remains in a porous structure

The properties of the aerogels of the present disclosure may be selectively tuned as desired by modifying the compositions (e.g., the amount and type of materials used in the formulations), the processing conditions or other parameters, such as post-treatment methods, such as surface-coating the aerogel to achieve desired properties (e.g., hydrophobicity). Specific examples of such selective tuning is provided in the test examples below.

### Test Data

Various aerogel compositions having differing concentrations of alcohol and water-soluble polymer were prepared and tested according to the teachings of the present disclosure. Control aerogel concentrations having no alcohol were also prepared and tested.

The working examples were produced according to the following procedure. First, a first group of working examples were prepared according to the following procedure. Up to 200 ml of distilled water was added to a beaker and placed onto a hot plate stirrer (e.g., 200 ml water, 150 ml water, and 175 ml water). The hot plate stirrer was set to a high heat setting and low stirring speed. A water-soluble polymer (e.g., PVA powder) of 4 g or 8 g was added to the beaker and the stirring of the solution continued until the solution changed from a solid white color to clear and the heat setting of the hot plate stirrer was turned off. Next, an amount of alcohol (e.g., ethanol) was optionally added to the solution until the volume of the solution was at about 200 ml (e.g., no ethanol was added to the solution of 200 ml water, 50 ml of ethanol was added to the solution of 150 ml of water and, 25 ml of ethanol was added to the solution of 175 ml of water). Altogether, four working examples were prepared under this first grouping per Table 1, below.

TABLE 1
First Group of Working Examples

| Example | Distilled Water (in ml) | Ethanol (in ml) | PVA (in g) |
|---|---|---|---|
| A | 150 | 50 | 4 |
| B | 150 | 50 | 8 |
| C | 175 | 25 | 4 |
| D | 175 | 25 | 8 |

For each working example, the contents were stirred for one minute and then poured into a tray having dimensions of 20×15×4 cm. Each tray was placed into a freezer at −20° F. for over 24 hours to allow the contents to freeze completely. The trays were removed from the freezer, and the frozen sample was removed from the tray and placed into a freeze dryer set to −1° C. and held in the freeze dryer for 3 days.

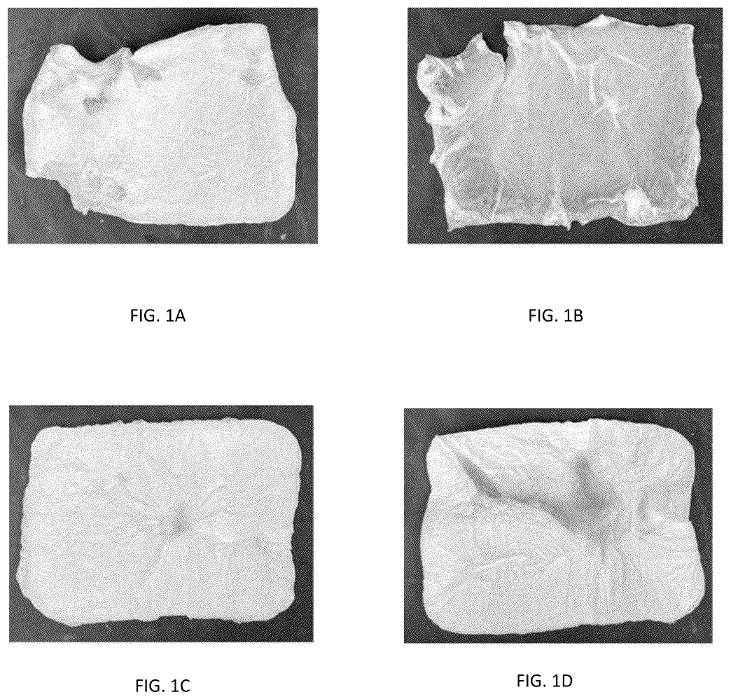

Referring to FIGS. 1A-1D, none of the working examples of the first grouping formed satisfactory aerogels after 3 days of freeze drying because none of the working examples were adequately dried after 3 days. More specifically, the working examples showed warpage at their corners and appeared wet. Simply, the capacity of the freeze dryer was not sufficient to adequately dry the working examples or inhibit warpage of the working examples.

A second group of working examples were prepared according to the method for preparing the first group of working examples, except that each working example, after freezing, was cut into four rectangular pieces and freeze dried thereafter individually. In other words, the four working examples according to Table 1 were each prepared, then each of the four working examples were cut up into four pieces, and then those four pieces were each freeze dried separately from the other working examples. Altogether, four working examples were prepared under this second grouping per Table 2, below.

TABLE 2
Second Group of Working Examples

| Example | Distilled Water (in ml) | Ethanol (in ml) | PVA (in g) |
|---|---|---|---|
| E | 150 | 50 | 4 |
| F | 150 | 50 | 8 |
| G | 175 | 25 | 4 |
| H | 175 | 25 | 8 |
| I | 200 | 0 | 4 |
| J | 200 | 0 | 8 |

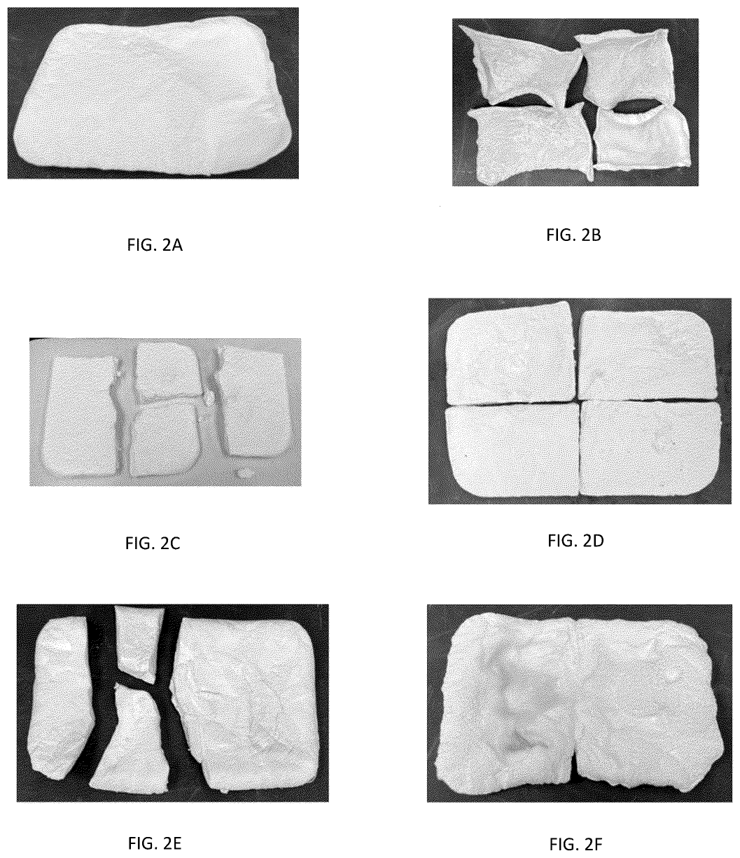

Referring to FIGS. 2A-2F, these working samples showed less evidence of warpage and appeared to have dried much more successfully than the working examples of the first group of working examples.

A third group of working examples were prepared according to the method for preparing the first group of working examples, except that each working example, after freezing, was freeze dried individually. Altogether, two working examples were prepared under this third grouping per Table 3, below.

TABLE 3
Third Group of Working Examples

| Example | Distilled Water (in ml) | Ethanol (in ml) | PVA (in g) |
|---|---|---|---|
| K | 175 | 25 | 4 |
| L | 200 | 0 | 4 |

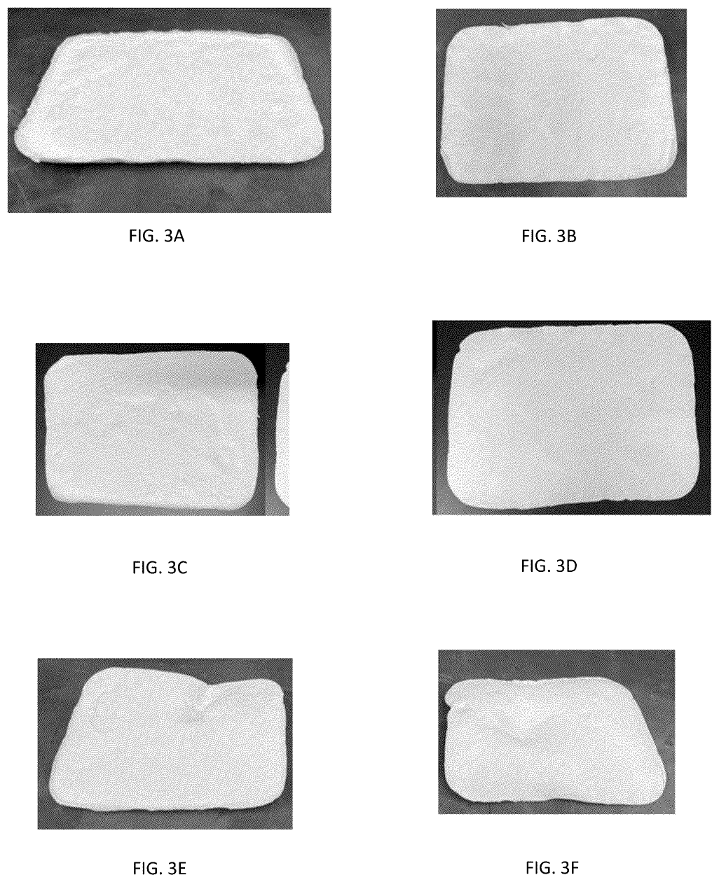

Referring to FIGS. 3A-3F, these working samples also showed less evidence of warpage and appeared to have dried much more successfully than the working examples of the first group of working examples.

The resultant aerogels of the working examples of the first group of working examples and the second group of working examples had their thermal conductivity and density tested. The second group of working examples further had their compressive stress tested. For the third group of working examples, the density was tested after 1 day of freeze drying, again after 2 days of freeze drying, and a third time after 3 days of freeze drying.

The weight of remaining solvent was calculated based off the observed weight of the working sample subtracted by the expected weight of the working sample. The weights of the samples are shown in Table 4, below.

TABLE 4
Weight of Remaining Solvent (g)

| Example | Weight (g) |
|---|---|
| A | 0.941 |
| B | 26.684 |
| C | 0.843 |
| D | 8.221 |
| E | 0.515 |
| F | 7.492 |
| G | 0.219 |
| H | −0.375 |
| I | 0.04 |
| J | 13.046 |
| K (after first day) | 82.731 |
| K (after second day) | 5.779 |
| K (after third day) | 0.651 |
| L (after first day) | 59.591 |
| L (after second day) | 7.373 |
| L (after third day) | 1.331 |

The thermal conductivity of the first group of working examples and the second group of working examples was determined by the rate heat transfers through them. For working examples having portions of the aerogel composition that adequately dried and portions of the aerogel composition that did not adequately dry, thermal conductivity was measured at loci where the working example had adequately dried (referred to as a dry locus) and at loci where the working example did not adequately dry (referred to as a wet locus). The thermal conductivity of the samples is shown in Table 5, below.

TABLE 5
Thermal Conductivity (W/mK)

| Example | Thermal Conductivity (W/mK) |
|---|---|
| A (dry locus) | 0.656 |
| B (wet locus) | 0.3242 |
| C (dry locus) | 0.0594 |
| D (dry locus) | 0.0964 |
| D (wet locus) | 0.287 |
| E (dry locus) | 0.0402 |
| E (wet locus) | 0.0428 |
| F (wet locus) | 0.0486 |
| G (dry locus) | 0.0305 |
| H (dry locus) | 0.0349 |
| I (dry locus) | 0.0338 |
| J (dry locus) | 0.0312 |

The compressive properties of some of the examples of the second group of working examples were also tested. Compressive stress results of such examples are provided in Table 6, below.

TABLE 6

| | Sample E | Sample G | Sample H | Sample I |
|---|---|---|---|---|
| Compressive Modulus | 0.3393 | 0.33943 | 1.13259 | 0.6251 |
| Maximum Compressive Stress (MPa) | 0.11629 | 0.08111 | 0.24499 | 0.13587 |
| Compressive Stress 5% Strain (MPa) | 0.00745 | 0.00186 | 0.00352 | 0.00114 |
| Compressive Stress 10% Strain (MPa) | 0.01646 | 0.00497 | 0.01534 | 0.00315 |
| Compressive Stress 15% Strain (MPa) | 0.02575 | 0.00965 | 0.02552 | 0.00762 |
| Compressive Stress 20% Strain (MPa) | 0.03383 | 0.01526 | 0.3384 | 0.01343 |
| Compressive Stress 25% Strain (MPa) | 0.04087 | 0.02055 | 0.04315 | 0.01934 |
| Compressive Stress 30% Strain (MPa) | 0.04739 | 0.02511 | 0.05351 | 0.2588 |
| Compressive Stress 35% Strain (MPa) | 0.05367 | 0.0292 | 0.06437 | 0.03313 |
| Compressive Stress 40% Strain (MPa) | 0.05978 | 0.03306 | 0.0756 | 0.0407 |
| Compressive Stress 45% Strain (MPa) | 0.06577 | 0.03717 | 0.08817 | 0.04882 |
| Compressive Stress 50% Strain (MPa) | 0.07193 | 0.04145 | 0.10367 | 0.0583 |
| Compressive Stress 55% Strain (MPa) | 0.07887 | 0.04673 | 0.12415 | 0.07002 |
| Compressive Stress 60% Strain (MPa) | 0.08737 | 0.05425 | 0.15161 | 0.08542 |
| Compressive Stress 65% Strain (MPa) | 0.09887 | 0.06501 | 0.19067 | 0.10623 |

As can be extrapolated from the data provided herein, as the amount of PVA increases, the rate of removing the solvent decreases. When an adequate amount of the solvent is not removed, such as Examples A-D, the aerogel appears wet or does not have a solid white appearance (see also FIGS. 1A-1D). Rather, the aerogel appear very thin, have a squishy texture, and do not offer much structural support. Samples that have adequately dried, however, have a solid white appearance and have a texture similar to closed-cell extruded polystyrene foam due to their low density and high porosity, such as Example G.

The data further shows that as the amount of PVA increases, the thermal conductivity of the aerogel increases, which is expected since generally this relates to a lower density or porosity of the aerogel.

The data also suggests that adding ethanol facilitates the rate at which solvent is removed during freeze drying. Surprisingly, however, it was found that aerogels prepared from a solvent including ethanol at about 12.5% by volume resulted in an aerogel having better thermal conductivity than aerogels prepared with greater or lesser amounts of ethanol. Generally, aerogels with lower thermal conductivities are more desirable.

The data also suggests that aerogels prepared from solvents including greater concentrations of ethanol and greater PVA concentrations resulted in higher compressive stress at a majority of the different compression strains and more specifically from 5% to 60% strain. Higher compressive strength aerogels are often desirable, but there is a balance that must be struck between the desirability of higher compressive strength at the cost of higher densities and higher thermal conductivities. The aerogel compositions disclosed hereunder may be used in various automotive applications and for vehicle components requiring the properties disclosed hereunder.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of forming a polymer-based aerogel, the method comprising:
mixing a solvent with a water-soluble polymer to form a polymer mixture;
mixing the polymer mixture with an alcohol to form an aerogel mixture; and
freeze drying the aerogel mixture to sublimate at least a portion of the solvent and alcohol from the aerogel mixture to form the polymer-based aerogel.

2. The method according to claim 1, wherein the solvent comprises water.

3. The method according to claim 2, wherein the alcohol comprises ethanol.

4. The method according to claim 3, wherein the water-soluble polymer comprises polyvinyl alcohol powder.

5. The method according to claim 4, wherein the ethanol comprises greater than 0% to less than or equal to about 25% by volume of the aerogel mixture.

6. The method according to claim 1, wherein the alcohol comprises greater than 0% to less than or equal to about 25% by volume of the aerogel mixture.

7. The method according to claim 1, wherein the alcohol comprises about 12.5% by volume of the aerogel mixture.

8. A method of forming a polyvinyl alcohol (PVA) aerogel, the method comprising:
mixing water with PVA to form a PVA mixture;
mixing the PVA mixture with ethanol to form an aerogel mixture; and
freeze drying the aerogel mixture to sublimate at least a portion of the water and ethanol from the aerogel mixture to form the PVA aerogel.

9. The method of claim 8, wherein the ethanol comprises greater than 0% to less than or equal to about 25% by volume of the aerogel mixture.

10. The method of claim 8, wherein the ethanol comprises about 12.5% by volume of the aerogel mixture.

11. The method of claim 8, wherein the PVA aerogel comprises pores having an average diameter of greater than or equal to about 6 nanometers to less than or equal to about 400 nanometers.

12. The method of claim 8, wherein the density of the PVA aerogel is about 0.02 g/cm³.

13. The method of claim 8, wherein the PVA aerogel has a thermal conductivity of less than or equal to about 0.0305 W/mK.

14. A method of forming a polyvinyl alcohol (PVA) aerogel, the method comprising:
mixing a solvent with a PVA to form a PVA mixture;
mixing the PVA mixture with an alcohol to form an aerogel mixture; and
freeze drying the aerogel mixture to sublimate at least a portion of the solvent and alcohol out of the aerogel mixture to form the PVA aerogel.

15. The method according to claim 14, wherein the solvent comprises water.

16. The method according to claim 14, wherein the alcohol comprises ethanol.

17. The method according to claim 14, wherein the alcohol comprises greater than 0% to less than or equal to about 25% by volume of the aerogel mixture.

18. The method according to claim 14, wherein the alcohol comprises about 12.5% by volume of the aerogel mixture.

19. The method according to claim 14, wherein the PVA aerogel comprises pores having an average diameter of greater than or equal to about 6 nanometers to less than or equal to about 400 nanometers.

20. The method of claim 14, wherein the density of the PVA aerogel is about 0.02 g/cm³.
